(19) United States
(12) Patent Application Publication
(10) Pub. No.: US 2024/0102580 A1
(43) Pub. Date: Mar. 28, 2024

(54) VALVE HEATING ARRANGEMENT

(71) Applicant: Goodrich Corporation, Charlotte, NC (US)

(72) Inventors: Piotr KROCZEK, Nieciszow (PL); Lukasz TUREK, Wroclaw (PL); Dariusz SAPIJA, Kielczowek (PL)

(21) Appl. No.: 18/466,372

(22) Filed: Sep. 13, 2023

(30) Foreign Application Priority Data
Sep. 28, 2022 (EP) 22461611.0

(51) Int. Cl. F16K 49/00; B33Y 10/00; B33Y 40/20; B33Y 80/00

(52) U.S. Cl. CPC F16K 49/002; B33Y 10/00; B33Y 40/20; B33Y 80/00; F16K 5/0605

(57) ABSTRACT

A heating arrangement for a valve includes a thermally conductive heating wire embedded within a body of the valve. Also provided is a valve body formed by additive manufacture and having a thermally conductive heating wire embedded therein to which electric power is applied to cause the thermally conductive heating wire to generate heat in the valve body. A method of manufacture is also provided.

### CROSS REFERENCE TO RELATED APPLICATIONS

This application claims priority to European Patent Application No. 22461611.0 filed Sep. 28, 2022, the entire contents of which is incorporated herein by reference.

### TECHNICAL FIELD

The present disclosure is concerned with providing heating for valves and valve components e.g. to prevent freezing.

### BACKGROUND

Valves of many types are known to regulate the flow of fluid through a system. Such valves can be manual or motorized. Mechanical, hydraulic and electrical valves are known and used in many fields. Often, such valves and associated pipes are required to operate in extreme environments and are required to be able to continue to operate reliably in environments where e.g., contamination, vibration, pressure and or temperatures can impact operation. One field of application where the valve components are subjected to particularly low temperatures is in the aerospace field. Valves are used to drain fluid from water systems in the aircraft or to drain water that has accumulated in parts of the aircraft such as the fuel tank. Hydraulic valves are also used to control moveable parts of the aircraft such as flight control panels. Components such as water pipes and valves designed for aerospace applications often face many unique challenges. One of the main challenges is high altitude operation with ambient temperatures around −45° C. (−50° F.). At such temperatures, water in or around the valve parts can freeze and prevent reliable operation of the valve. For this reason, many valves require some form of heating to prevent water in or on the valve from freezing.

Typically, silicone heaters are used since these can be formed as flexible sheets or sleeves and fitted around the parts of the valve that require heating.

Although silicone heaters provide an effective and simple solution, silicone has fairly low mechanical properties and so can be damaged during installation or during normal use of the valve and may need to be replaced frequently. Further, the known silicone heaters are provided as a layer around the valve/pipes. This results in an overall increase of the size of the valve/pipes and therefore requires more space for installation. In aircraft, and other applications where space is limited, this can be disadvantageous.

There is, therefore, a need for a simple way of providing heating to valves that avoids these problems.

### SUMMARY

According to this disclosure, there is provided a heating arrangement for a valve, comprising a thermally conductive heating wire embedded within a body of the valve. Also provided is a valve body formed by additive manufacture and having a thermally conductive heating wire embedded therein to which electric power is applied to cause the thermally conductive heating wire to generate heat in the valve body. A method of manufacture is also provided.

### BRIEF DESCRIPTION

Examples of the valve heating arrangement of the disclosure will be described below with reference to the drawings. It should be noted that variations are possible within the scope of the claims.

The arrangement will be described with particular reference to valves used in aerospace, but the inventive concept can be equally applied to valves used in other applications where heating is required and the scope of the invention is not limited to any particular application or type of valve.

FIG. 1 shows an example of a typical valve provided with a known silicone heater.

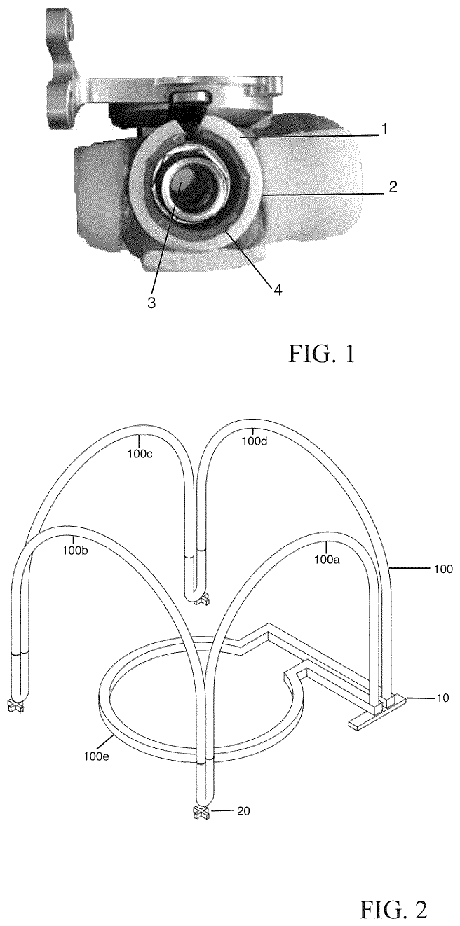

FIG. 2 shows an example of a heater according to this disclosure.

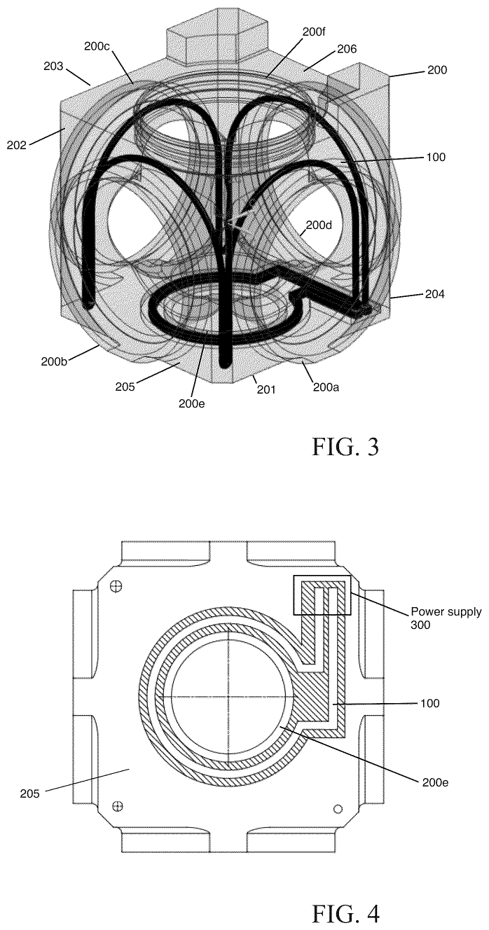

FIG. 3 shows an example of a heater according to the disclosure incorporated into a valve body.

FIG. 4 shows a bottom view of the example of FIG. 3.

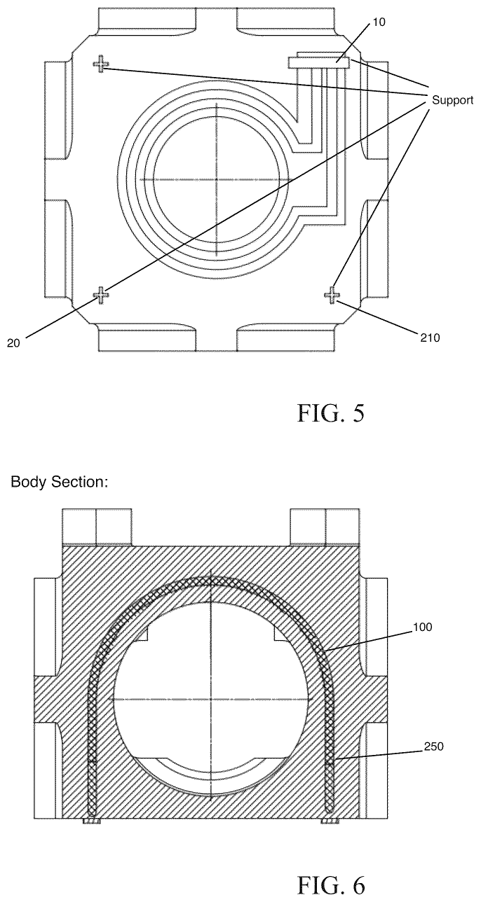

FIG. 5 shows further details of the example of FIG. 3 during manufacture.

FIG. 6 shows a side view of the example in FIG. 5 at a stage of forming the heater.

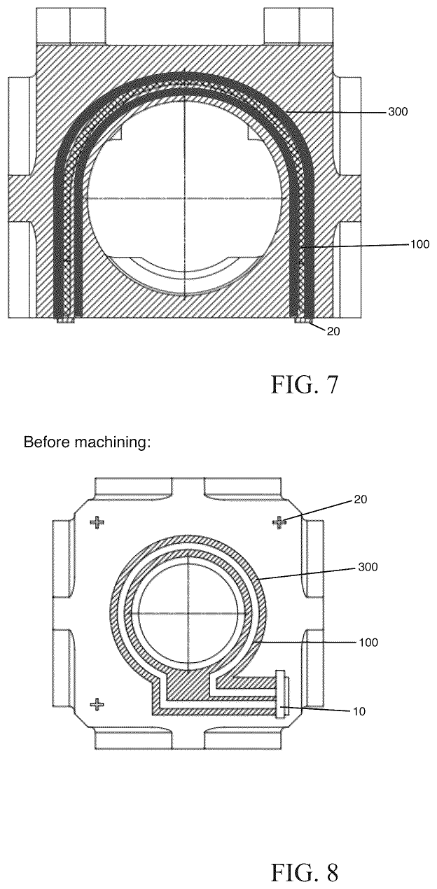

FIG. 7 shows the view of FIG. 6 at a subsequent stage of forming the heater.

FIG. 8 shows the view of FIG. 7 at a subsequent stage of forming the heater.

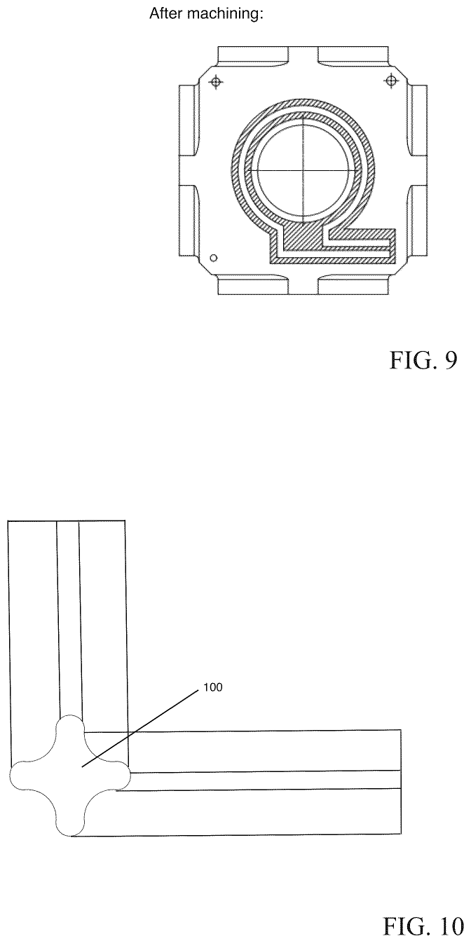

FIG. 9 shows the view of FIG. 8 at a subsequent stage of forming the heater.

FIG. 10 shows and example of a wire that may be used for the heater according to the disclosure.

### DETAILED DESCRIPTION

With reference to FIG. 1, a conventional valve heating arrangement will be described by way of background.

A typical valve comprises a valve body 1 having a number of ports 2 and defining a fluid flow passage 3 therethrough between the ports. The valve regulates the flow of fluid in different ways depending on the type of valve, but essentially a valve component e.g. a ball, moves relative to the valve body to open and close the fluid flow passage as required. The present invention is not limited to any particular type of valve.

In the conventional arrangement, where the valve is at risk of freezing at low temperatures, silicone heater elements 4 are wrapped around the outside of the valve parts.

As can be seen, this adds to the overall dimensions of the valve and, further, the heater elements may be vulnerable to damage.

In recent times, additive manufacturing (or 3D printing) processes have been developed and improved to an extent that more and more components can be made in this way. Using additive manufacturing enables more flexibility in the sizes and more complexity in the shapes of components that can be manufactured. Desired shapes and sizes can be manufactured quickly and on an ‘as needed’ basis thus also reducing storage requirements. Additive manufacturing is now becoming a more common way of manufacturing valve bodies and valve parts. The solution provided by the present invention takes advantage of this development.

The heating arrangement of this invention involves using a heating wire that is located within the valve body during formation of the valve body by additive manufacturing, as will be described in more detail below.

Rather than using sheets or sleeves of silicone provided on the outside of the valve body, the present invention uses a thermally conductive wire that is located within a channel formed in the valve body during additive manufacture.

The heating wire can be sized, shaped and arranged in any manner according to the size and shape of the valve body and the locations where heating is required. An example of a heating wire 100 structure is shown in FIG. 2. This example would be suitable for an essentially cuboid valve body having a port in each of the four side walls and a fluid flow passage from a port in the bottom wall to a port in the top wall (see FIG. 3). In the example shown, the (conductive) heating wire 100 forms a loop to fit around the valve body defining a heating wire arch 100a, 100b, 100c, 100d around each of the ports in the side walls of the valve body and a heating wire loop 100e around the port in the bottom wall. FIG. 2 also shows support members 10, 20 used to locate the heater wire during manufacture as described further below. The wire ma be shaped and arranged differently for different valve bodies or different heating requirements.

FIG. 3 shows the heating wire 100 located within the valve body 200. The valve body having a port 200a, 200b, 200c, 200d in each of its side walls 201, 202, 203, 204, as well as a port 200e in the bottom wall 205 and a port 200f in the top wall 206. The wire provides heating to the valve body 200 by application of electricity to the wire from outside the valve body. FIG. 4 shows an example in which electric power 300 is provided to the heating wire 100 where it starts and ends in the bottom wall but power could be provided to heat the wire from other locations. Other valve bodies may have different shapes and/or different numbers of ports. The heating wire may provide heating at each port or only at some ports.

The manner in which the heating arrangement is formed will now be described in more detail, by way of example only, with reference to FIGS. 5 to 9.

The valve body and the heating wire are printed in a single additive manufacturing, AM, process to provide a single part. The valve body 200 is formed, using AM, in the desired shape and size and with the desired port and fluid flow passage configuration and, during the printing or building up of the valve body, a channel or recess is formed within the valve body defining the location where the heating wire is to be positioned. In the example shown, this involves defining a channel or recess 250 around each of the valve body ports. FIG. 5 shows an example of the bottom wall and FIG. 6 shows an example of a side wall.

The heating wire 100 is then located in the printed channel/recess 250 as seen in e.g. FIGS. 5 and 6. To ensure the wire is properly located and remains in place during the rest of the formation process, preferably support elements 10, 20 are provided at various locations along the wire. These may be in the form of shaped support blocks or fasteners that engage with the heating wire and with the valve body to hold the wire in place relative to the valve body. Holes 210 may be provided in the valve body where parts of the heating wire 100 are anchored by the support elements tat protrude through the holes. In the example shown, the support members are provided at locations at the bottom of each arch formed around a port. In the example, the supports at the legs of the arches are X-shaped. An additional support 10 is provided where the heating wire starts and finishes—which, in this example, is at the bottom wall of the valve body and, in this example, is a rectangular support plate.

Once the wire has been positioned in the valve body as desired, and is temporarily held in place by the supports (in preferred examples), a filler material 300 is provided around the heating wire 100 in the channel/recess, as shown in FIG. 7, to secure the wire and to fill any gap between the wire and the channel. The filler material should be thermally conductive e.g. a thermally conductive epoxy resin. The filler material 300 may also be electrically insulative to prevent electrical charge passing to the valve body. FIG. 8 shows the bottom side of the valve body after the filling step.

Once the heating wire 100 is secured in place in the channel 250 by the filler material 300, the supports can be machined away as seen in FIG. 9 to remove any protrusions from the valve body and leave a relative smooth finish. Removing the support elements (if they were used) means that there is no mechanical connection between the valve body and the heating wire and the filler material 300 provides electrical isolation between the wire and the valve body. The heating wire is fully protected from the external environment.

As mentioned above, the shape and dimensions of the wire can be varied according to heating requirements. The wire ma be a simple circular cross-section wire. Alternatively, the wire may have a non-circular cross-section e.g. an X-shaped cross-section, as shown in FIG. 10, or splined, dimpled or other irregular cross-section. Cross-sections such as that shown in FIG. 10 or with other irregularities provide an increased external surface area of wire compared to a circular cross-section thus allowing for more heat transfer.

By providing heating to a valve by incorporating a heating wire into an additively manufactured valve body, the heating element is fully provided within the envelope of the valve body thus not adding to the overall size of the valve and also not leaving the heating elements exposed and subject to external environment damage such as mechanical loads and chemical damage. Also, because the heating wire is formed with the valve body during additive manufacture, the desired shape of heating wire can be formed easily and quickly according to the specific requirements of the valve being manufactured. There is, therefore, flexibility, during manufacture, to adapt to different temperature and other product requirements.

1. A heating arrangement for a valve, the arrangement comprising:
a thermally conductive heating wire embedded within a body of the valve.

2. The heating arrangement of claim 1 wherein the heating wire has a non-circular cross-section.

3. The heating arrangement of claim 2, wherein the heating wire has a splined cross-section.

4. The heating arrangement of claim 2, wherein the heating wire has an X-shaped cross-section.

5. A valve body formed by additive manufacture and having a thermally conductive heating wire embedded therein to which electric power is applied to cause the thermally conductive heating wire to generate heat in the valve body.

6. The valve body of claim 5, wherein a recess is defined within the valve body during additive manufacture of the valve body, the heating wire located within the recess.

7. The valve body of claim 5, further comprising a filler material around the heating wire within the valve body.

8. The valve body of claim 7, wherein the filler material is a thermally conductive filler material.

9. The valve body of claim 8, wherein the filler material is epoxy resin.

10. The valve body of claim 9, wherein the filler material is electrically insulative.

11. The valve body of claim 5, comprising a plurality of ports.

12. The valve body of claim 11, wherein the heating wire is located around one or more of the plurality of ports.

13. The valve body claim 5, wherein the heating wire has a non-circular cross-section.

14. The valve body of claim 13, wherein the heating wire has a splined cross-section.

15. The valve body of claim 14, wherein the heating wire has an X-shaped cross-section.

16. A method of forming a valve body, the method comprising:
forming a valve body structure using additive manufacturing;
defining a channel within the valve body during the additive manufacturing; and
locating a thermally conductive heating wire in the channel during the additive manufacturing such that electric power can be applied to the heating wire to generate heat in the valve body.

17. The method of claim 16, further comprising securing the heating wire in position in the channel relative to the valve body by support elements.

18. The method of claim 17, further comprising:
providing a filler material around the heating wire in the channel to secure the heating wire in the channel.

19. The method of claim 17, further comprising:
machining the support elements away after the additive manufacturing.
